(19) United States
(12) Patent Application Publication
(10) Pub. No.: US 2015/0271325 A1
(43) Pub. Date: Sep. 24, 2015

(54) METHOD FOR NON-CONTACT INCOMING CALL REJECTION AND COMMUNICATION SYSTEM USING THE SAME

(71) Applicant: YUAN ZE UNIVERSITY, Chung-Li City (TW)

(72) Inventors: Chien-Cheng LEE, Taoyuan City (TW); Shang-Fei SHEN, Bade City (TW)

(73) Assignee: YUAN ZE UNIVERSITY, Chung-Li City (TW)

(21) Appl. No.: 14/223,520

(22) Filed: Mar. 24, 2014

(51) Int. Cl. H04M 3/436; H04W 4/16; H04W 4/00

(52) U.S. Cl. CPC H04M 3/436; H04W 4/008; H04W 4/16

(57) ABSTRACT

Disclosed is a method for non-contact incoming call rejection and a communication system using the same. The method generally includes the steps of entering into a normal operation mode to check if a call rejection signal is received when a call message is received, checking, entering into a call rejection mode and turning off the prompt device if the call rejection signal is received, checking if the call rejection signal continues, turning off the call rejection mode and recovering the original settings of the prompt device if the call rejection signal does not continue, returning back to the normal operation mode, and repeating the subsequent steps. Therefore, the present invention automatically enters into the call rejection mode based on the call rejection message transmitted by the near field wireless communication device without performing any physical operation. Particularly, the present invention is suitable for the communication device for driving.

### BACKGROUND OF THE INVENTION

1. Field of the Invention

The present invention generally relates to a method for non-contact incoming call rejection and a communication system using the same, and more specifically to a method for non-contact incoming call rejection by receiving or detecting a call rejection signal from a rejection control device so as to drive a mobile communication device to operate in a call rejection mode, thereby implementing a function of non-contact incoming call rejection, and a communication system using the same.

2. the Prior Arts

With the increasing progress of the semiconductor technology recently, various electronic products have provided more complex and versatile functions, especially the handed consumer electronic products like mobile phone. This mobile device with the key feature of much lighter, thinner, shorter and smaller size becomes more popular in the current market. Therefore, the modern mobile phone which is easily carried and used to make or receive a call any time substantially seems the basic equipment for everyone now.

However, the mobile phone is sometimes forced to enter into the incoming call rejection mode on some occasion like driving so as to avoid affecting the safety due to serious interference upon receiving the incoming call, or alternatively, at certain important meeting, concert or theater to prevent the prompt action such as flash light sign or vibration from deteriorating the on-site order, music performance or movie quality.

For the practical applications, the user needs to activate the incoming call rejection function in the prior arts by touching the specific key of the mobile phone or the specific icon on the touch screen through some preset procedure. It is thus not only complex for the general user to perform, but also possible to forget switching the current operation mode of the mobile phone to the rejection mode, especially when the user is driving the automobile, leading to potential risk because of distracting the user's focus.

Moreover, the entry of the concert or theater is commonly provided with the obvious sign or repeatedly broadcasting the message to remind the audience to set the mobile phone to the rejection mode. When the performance is ready to play, all the audience is once again reminded, but some people still forget or disregard switching to the rejection mode, resulting in great troubles for the on-site assistants.

For the near field communication applications, many communication techniques with stable function like Bluetooth, Near Field Communication (NFC) or Radio Frequency Identification (RFID) are developed by the vendors or associations to integrate into the present handed communication device. In particular, the NFC technique is intended to enforce the traditional RFID and provides the additional advantage of simpler operation to implement the function of wireless data transfer and storage within the short distance without any physical contact. The electronic ticket for the current city bus and MRT (Mass Rapid Transit) is one of the typical examples by use of the NFC technique.

As with the application field of communication, the manufactures have successfully developed the smart phone with built-in NFC function, which is ready to replace credit cards, or some mobile phones are provided with MRT, bus ticket, airplane boarding pass or entry card. Even the function of storing money, payment of small amount, or downloading of music or coupon is also included for now.

However, the present mobile phone does still not provide the function of automatic incoming call rejection by use of the NFC technique. Instead of being forced to enter into the rejection mode, only the function of automatically switching to the vibration, silence or flash light sign mode in response of the incoming call is implemented such that the user is easily distracted when receiving the call, leading to serious risk.

It is obvious that a new method for non-contact incoming call rejection by use of the non-contact NFC technique is needed to provide to automatically switch the operation mode of the mobile phone to the incoming call rejection mode when the call rejection signal is received, and a communication system using the same, thereby improving the convenience and overcoming the problems in the prior arts.

### SUMMARY OF THE INVENTION

The primary object of the present invention is to provide a method for non-contact incoming call rejection used in the smart communication device. The present invention generally comprises the steps of: entering into a normal operation mode, in which when a call message is received, a prompt device for generating sound, vibration or prompt flash light sign is activated, wherein the call message comes from a communication base station; checking if a call rejection message transmitted by a near field wireless communication device is received; if the call rejection message is received, entering into a incoming call rejection mode, in which the prompt device is turned off; checking if the call rejection message continues; if the call rejection message does not continue, turning off the incoming call rejection mode and recovering the original settings of the prompt device; and returning to the first step of entering into a normal operation mode and repeating the subsequent steps.

In addition, another object of the present invention is to provide a communication system using the method for non-contact incoming call rejection. The communication system comprises a rejection control device and a mobile communication device. The rejection control device provides the function of near field wireless communication, and transmits a call rejection signal. The mobile communication device receives the call rejection signal, and directly performs the incoming call rejection mode.

Specifically, the rejection control device generally comprises a central processing unit, a near field wireless communication device and a signal transmit antenna. The central processing unit executes the command of transmitting the call rejection signal, the near field wireless communication device transmits the call rejection signal, and the signal transmit antenna broadcasts the call rejection signal over the effective range. The mobile communication device may comprise a central processing unit, a near field wireless communication device, a signal receive antenna and a prompt device. The prompt device is preferably implemented by a specific module comprising a speaker, vibration generator and/or incoming call signal light source. The signal receive antenna can receive the call rejection signal within an effective region of the rejection control device, and further transfer the call rejection signal to the central processing unit through the near field wireless communication device. The central processing unit generates the control command based on the call rejection signal for turning off and ceasing the action of the prompt device, and at the same time, the current operation mode is switched to the incoming call rejection mode.

Therefore, the rejection control device of the present invention is suitable to be installed in the automobile like the location in the vicinity of the driver seat such that the call rejection signal transmitted by the near field wireless communication device is detected or received when the driver gets in the automobile and the incoming call rejection mode is automatically activated without any manual operation. Alternatively, the concert or movie theater can be provided with the rejection control device, which is used to inform the audience's mobile phones to enter into the incoming call rejection mode, and the prompt device of the mobile phone is compulsorily turned off.

### BRIEF DESCRIPTION OF THE DRAWINGS

The present invention can be understood in more detail by reading the subsequent detailed description in conjunction with the examples and references made to the accompanying drawings, wherein:

FIG. 1 is a flowchart showing a method for non-contact incoming call rejection according to the present invention; and

FIG. 2 is a view showing a communication system using the method for non-contact incoming call rejection according to the present invention.

### DETAILED DESCRIPTION OF THE PREFERRED EMBODIMENT

The present invention may be embodied in various forms and the details of the preferred embodiments of the present invention will be described in the subsequent content with reference to the accompanying drawings. Modifications of the shape of the present invention shall too be considered to be within the spirit of the present invention.

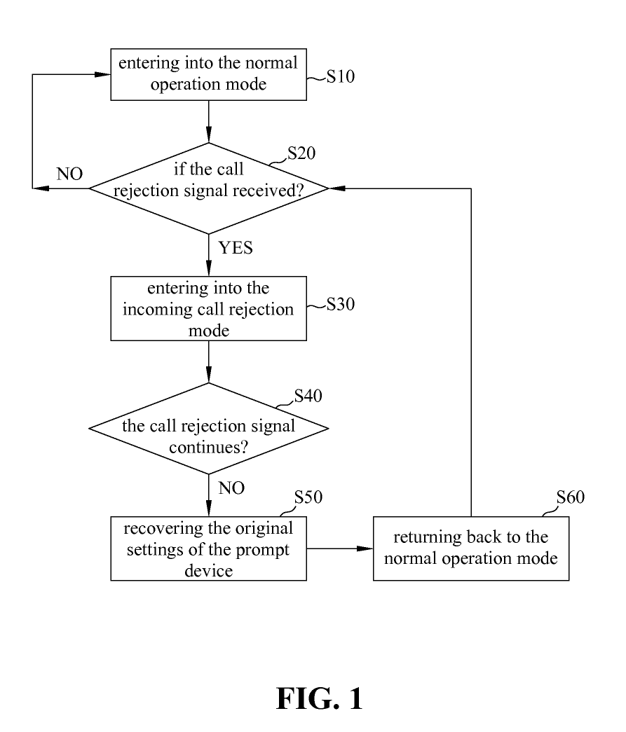

Please refer to FIG. 1 showing the flowchart of the method for non-contact incoming call rejection according to the present invention. As shown in FIG. 1, the method of the present invention generally comprises the sequential steps S10, S20, S30 S40 and S50 for implementing the function of incoming call rejection, applicable to smart communication devices or smart phones.

First, the method for non-contact incoming call rejection of the present invention starts at the step S10, entering into the normal operation mode, in which the prompt device is turned on. When the incoming call message is received, the prompt device performs the prompt action such as sound, vibration or prompt flash light sign. The incoming call message is transmitted by the communication base station.

Next, the step S20 is performed by checking whether the call rejection signal from the near field wireless communication device within a suitable range is received. If the call rejection signal is received, the step S30 is executed to enter into the incoming call rejection mode, in which the prompt device is turned off That is, the prompt device does not perform any action even the incoming call message is received.

Preferably, the above call rejection signal is implemented by the wireless communication technique like Bluetooth, NFC or RFID.

In addition, after the step S30 of entering into the incoming call rejection mode, if the incoming call message transmitted by the incoming side is received, the reply action by use of playing the answering message of the receiving side or transmitting a message in order to help the user of the incoming side well understand that the receiving side is operated at the incoming call rejection mode. At the same time, it is possible to further request the incoming side to leave words or message for call back or communication later. Therefore, no incoming call is missed.

Subsequently, in the step S40, it is checked whether the call rejection signal lasts for a preset period of time like 10 seconds. If yes, stay in the step S40. If not, enter into the step S50, in which the incoming call rejection mode is turned off and the original settings of the prompt device are recovered. Finally, the step S60 is performed by returning back to the step S20 of entering into the normal operation mode, and repeating the subsequent steps as mentioned above.

Therefore, the method of the present invention effectively solves the problem that the user is often bothered by the prompt action from the prompt device at some specific occasions, thereby maintaining the order and the environmental quality.

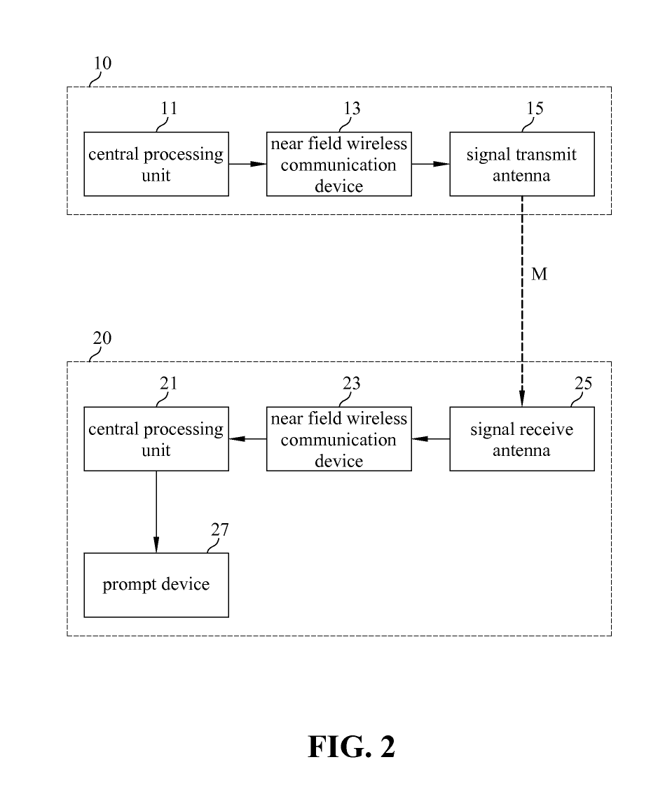

Further refer to FIG. 2 in order to illustratively explain the communication system using the method for non-contact incoming call rejection according to the present invention. As shown in FIG. 2, the communication system using the method of the present invention generally comprises the rejection control device 10 and the mobile communication device 20. The rejection control device 10 provides the function of near field wireless communication, and can transmit the call rejection signal. When the mobile communication 20 receives the call rejection signal, the incoming call rejection mode is directly performed.

It is preferred that the rejection control device 10 and the mobile communication device 20 employ Bluetooth, NFC or RFID to transmit and receive the call rejection signal.

Specifically, the rejection control device 10 may comprise a central processing unit 11, a near field wireless communication device 13 and a signal transmit antenna 15. The central processing unit 11 executes the command of transmitting the call rejection signal, the near field wireless communication device converts the command into the call rejection signal M and transmits it, and the signal transmit antenna 15 broadcasts the call rejection signal M over the effective range.

Furthermore, the mobile communication device 20 is implemented by a smart phone, a tablet computer or a handed device with the wireless communication function. The mobile communication device 20 generally comprises a central processing unit 21, a near field wireless communication device 23, a signal receive antenna 25 and a prompt device 27. The prompt device 27 preferably comprises a specific module implemented by at least one module of a speaker, vibration generator and/or incoming call signal light source, which generates respective prompt actions like sound, vibration, and light/flash light signal.

The signal receive antenna 25 may receive and transmit the call rejection signal M within the effective broadcasting range of the rejection control device 10. The near field wireless communication device 23 receives and converts the call rejection signal M into the executing command for the call rejection signal M. The central processing unit 21 receives the command and generates a corresponding control command for turning off the prompt device 27 and ceasing the prompt actions. At the same time, the current operation mode is switched to the incoming call rejection mode from the normal operation mode.

Subsequently, the mobile communication device 20 continuously detects the call rejection signal M and determines whether the call rejection signal M received lasts for a preset period of time like 10 seconds. If the call rejection signal M is sustained over the preset period of time, the mobile communication device 20 keeps running the incoming call rejection mode. If the call rejection signal M does not last for the preset period of time, the mobile communication device 20 returns back to the normal operation mode from the incoming call rejection mode. At this time, the original settings of the prompt device 27 are recovered such that the prompt device 27 performs the corresponding prompt action when the incoming call message is received.

It should be noted that the above central processing unit 11, near field wireless communication device 13 and signal transmit antenna 15 included in the rejection control device 10, and the central processing unit 21, near field wireless communication device 23 and signal receive antenna 25 included in the mobile communication device 20 are only illustrative examples for clearly describing the primary characteristics of the present invention, and substantially not intended to limit the scope of the present invention. In other words, all the components used in the present invention may comprise other electronic, electrical elements or units with the equivalent functions.

For the practical applications, the rejection control device of the present invention is preferably provided in the vicinity of the driver seat in the automobile. As a result, when the driver gets in the automobile and sits at the driver seat, the mobile communication device like mobile phone automatically detects the call rejection signal transmitted by the near field wireless communication device so as to activate the incoming call rejection mode without the driver's any physical or manual operation. Alternatively, the rejection control device can be directly connected to the power switch of the automobile such that the rejection control device is activated to real-time transmit the call rejection signal to the driver's mobile phone when the driver starts the automobile. The user may also employs the mobile communication device to proximately activate the automobile with NFC function, and at the same time, the call rejection signal transmitted by the rejection control device provided in the automobile is received by the mobile communication device, thereby automatically switching to the incoming call rejection mode.

Additionally, the rejection control device can be installed at the concert or theater to actively inform each audience's mobile phone of directly switching to the incoming call rejection mode and compulsorily ceasing any prompt action of the prompt device so as to maintain the environment of the occasion.

Therefore, as for the designs built with the function of automatically switching to the normal receive mode through a wireless sensing means, the method of the present invention in comparison with other techniques in the prior arts substantially possesses the following advantages:
(1) directly switching to the incoming call rejection mode in order to totally prevent the interference resulted from the incoming call, especially crucial for driving and formal/serious occasions; and
(2) using NFC technique to implement electronic sensing ticket or electronic sensing switch, and being capable of simultaneously switching the incoming call mode of the mobile phone for directly sensing and switching, resulting in convenience of use and possessing high reliability and fast response.

From the above-mentioned, one aspect of the present invention is that the wireless sensing NFC technique is used to allow the user without performing any physical operation to control and change the operation mode of the mobile communication device, which automatically and compulsorily enters into the incoming call rejection mode in a non-contact manner. As a result, no prompt action is activated when the incoming call message is received. In particular, it is possible to further send a reply message to the incoming side that the user is not available to receive the incoming call when the incoming call message is received, and at the same time, request the incoming side to leave a message for subsequent call back.

Another aspect of the present invention is that the method for non-contact incoming call rejection is applicable to the communication system, which manipulates the rejection control device to transmit the wireless call rejection message over the effective range. Also, the mobile communication device can receive the call rejection message and automatically switch the operation mode to the incoming call rejection mode. Thus, once the mobile communication device approaches to the rejection control device, the incoming call rejection mode is performed, proving great convenience for the user. Particularly, the present invention can be applied to the general automobile such that the mobile phone with the built-in NFC sensing function serves as the device to start the automobile, and at the same time, the mobile phone is automatically switched to the incoming call rejection mode, thereby avoiding the interference due to the incoming call and greatly improving the safety of driving. Moreover, when the driver leaves the driving seat of the automobile and does not receives the call rejection signal, the mobile phone can automatically return back to the normal operation mode to activate the prompt device.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for non-contact incoming call rejection, comprising steps of:
entering into a normal operation mode, in which when a call message is received, a prompt device for generating a prompt action is activated, wherein the call message comes from a communication base station;
checking if a call rejection message is received;
if the call rejection message is received, entering into an incoming call rejection mode, in which the prompt device is turned off and does not perform the prompt action when the call message is received;
checking if the call rejection message lasts for a preset period of time;
if the call rejection message does not last for the preset period of time, turning off the incoming call rejection mode and recovering original settings of the prompt device; and
returning back to the step of entering into the normal operation mode and repeating the subsequent steps.

2. The method as claimed in claim 1, wherein the prompt action comprises generating sound, vibration or prompt flash light sign.

3. The method as claimed in claim 1, wherein the call rejection message comes from a near field wireless communication device and is implemented by Bluetooth, Near Field Communication (NFC) or Radio Frequency Identification (RFID).

4. The method as claimed in claim 1, wherein the incoming call rejection mode is implemented by steps of:
performing a reply action by use of playing an answering message of a receiving side or transmitting a message in order to inform an incoming side of a status of incoming call rejection and at the same request the incoming side to leave a message for call back when the call message transmitted by the incoming side is received.

5. A communication system using a method for non-contact incoming call rejection, comprising:
a rejection control device with a function of near field wireless communication, comprising a central processing unit, a near field wireless communication device and a signal transmit antenna, wherein the central processing unit executes a command of transmitting a call rejection signal, the near field wireless communication device receives and converts the command into the call rejection signal, and the transmit antenna broadcasts the call rejection signal over an effective range; and
a mobile communication device with the function of near field wireless communication, comprising a central processing unit, a near field wireless communication device, a signal receive antenna and a prompt device, wherein the signal receive antenna receives and transfers the call rejection signal from the rejection control device to the near field wireless communication device, the near field wireless communication device processes the call rejection signal to generate a command of transmitting the call rejection signal, the central processing unit receives the command and generates a corresponding control command for turning off the prompt device, the mobile communication device is switched to an incoming call rejection mode from a normal operation mode and checks if the call rejection signal lasts for a preset period of time, and if the call rejection signal lasts for the preset period of time, the mobile communication device returns back to the normal operation mode from the incoming call rejection mode, and at the same recovers original settings of the prompt device when an incoming call message is received so as to activate the prompt device to perform a corresponding prompt action.

6. The communication system as claimed in claim 5, wherein the function of near field wireless communication is implemented by Bluetooth, NFC or RFID.

7. The communication system as claimed in claim 5, wherein the mobile communication device comprises a smart phone, tablet computer or mobile device with a wireless communication function.

8. The communication system as claimed in claim 5, wherein the prompt device comprises at least one module of a speaker, vibration generator and incoming call light source for generating the prompt actions of sound, vibration and light/flash light sign, respectively.

9. The communication system as claimed in claim 5, wherein the mobile communication device performs a reply action by use of playing an answering message of a receiving side or transmitting a message in order to inform an incoming side of a status of incoming call rejection, and at the same request the incoming side to leave a message for call back when the call message transmitted by the incoming side is receive.
